(19) United States
(12) Patent Application Publication
(10) Pub. No.: US 2010/0026873 A1
(43) Pub. Date: Feb. 4, 2010

(54) DIGITAL IMAGE PROCESSING APPARATUSES, METHODS OF CONTROLLING THE SAME, AND COMPUTER-READABLE MEDIUM ENCODED WITH COMPUTER EXECUTABLE INSTRUCTIONS FOR EXECUTING THE METHOD(S)

(75) Inventor: Jae-sung Lee, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/512,382

(22) Filed: Jul. 30, 2009

(30) Foreign Application Priority Data
Jul. 31, 2008 (KR) 10-2008-0075336

(51) Int. Cl. H04N 5/222

(52) U.S. Cl. 348/333.05; 348/333.11; 348/E05.024

(57) ABSTRACT

Digital image processing apparatuses, methods of controlling the same, and computer-readable medium encoded with executable instructions for executing the method(s). The digital image processing apparatus is configured to simultaneously display a quick view image and a preview image on a display device. The digital image processing apparatus may have the advantage of reducing a time interval between photographing operations.

### CROSS-REFERENCE TO RELATED PATENT APPLICATION

This application claims the benefit of Korean Patent Application No. 10-2008-0075336, filed on Jul. 31, 2008 in the Korean Intellectual Property Office, the entire contents of which is incorporated herein by reference.

### BACKGROUND OF THE INVENTION

1. Field of the Invention

The present invention relates to a digital image processing apparatus and a method of controlling the same, and more particularly, to a digital image processing apparatus that can simultaneously display a quick view image and a preview image to reduce a time interval between photographing operations.

2. Description of the Related Art

Many conventional digital image processing apparatuses support displaying a photographed image for a predetermined time right after photographing an image. In many conventional digital image processing apparatus, the user cannot perform a next photographing operation when the photographed image is being displayed. This may frustrate the user because the user may at times want to view the displayed photograph, but at other times the user may want to immediately take another photograph.

Therefore, there is a need in the art for a digital processing apparatus that permits a user to both continue to photograph and to view previous photographs.

### SUMMARY OF THE INVENTION

Embodiments provide a digital image processing apparatus configured to simultaneously display a quick view image and a preview image.

The digital image processing apparatus may be further configured to display the quick view image on the preview image in a form of a picture-in-picture (PIP).

The digital image processing apparatus may be further configured to display the quick view image on the preview image for a predetermined time after a first photographing operation is finished.

The digital image processing apparatus may be further configured to perform a second photographing operation while the quick view image is being displayed on the preview image.

The digital image processing apparatus may be further configured to adjust at least one of a location of the quick view image in the preview image, a size of the quick view image, and a time of displaying the quick view image according to a user input.

Embodiments of a digital image processing apparatus may comprise: a display unit; and a digital signal processing unit, configured to display a preview image and a photographed image on the display unit at the same time.

The digital signal processing unit may further be configured to display the photographed image over the preview image as a pop-up window for a predetermined time.

The digital image processing apparatus may further be configured to perform a next photographing operation while the photographed image is being displayed on the display unit.

The digital image processing apparatus may be configured to respond to user input by at least one of adjusting a location of displaying the photographed image in the display unit, adjusting a size of the photographed image, and setting a time of displaying the photographed image.

The digital signal processing unit may be configured to control the display unit to stop displaying the photographed image when a predetermined time elapses.

Embodiments may comprise a method of controlling a digital image processing apparatus comprising a display unit. Embodiments of the methods comprise responsive to receiving a shutter-release signal, generating and storing an image file of a photograph; simultaneously displaying a preview image and the image file on the display unit; and stopping the displaying of the image file after a predetermined time elapses.

The responsive to receiving step may further comprise generating and storing a thumbnail image of the image file for displaying.

The simultaneously displaying step may further comprise simultaneously displaying the image file on the display unit as a pop-up window for the predetermined time.

The method may further comprise responsive to a predetermined signal input by a user during simultaneously displaying, performing an operation corresponding to the predetermined signal.

The method may further comprise responsive to a shutter-release signal input by a user while simultaneously displaying, performing a next photographing operation.

Embodiments comprise a computer readable medium encoded with computer-executable instructions to perform a method comprising: responsive to receiving a shutter-release signal, generating and storing an image file of a photograph; simultaneously displaying a preview image and the image file on the display unit; and stopping the displaying of the image file after a predetermined time elapses.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective front view of an example of a digital image processing apparatus according to an embodiment of the present invention;

FIG. 2 is a rear view of the example of the digital image processing apparatus of FIG. 1, according to an embodiment of the present invention;

FIG. 3 is a block diagram illustrating an example of a structure of the digital image processing apparatus illustrated in FIGS. 1 and 2, according to an embodiment of the present invention;

FIG. 4 is a diagram illustrating an example of a quick view image and a preview image displayed simultaneously on the digital image processing apparatus of FIGS. 1 and 2, according to an embodiment of the present invention; and

FIG. 5 is a flowchart illustrating an example of a method of controlling the digital image processing apparatus of FIGS. 1 and 2, according to an embodiment of the present invention.

### DETAILED DESCRIPTION OF THE INVENTION

Hereinafter, embodiments of the present invention will be described in detail with reference to accompanying drawings.

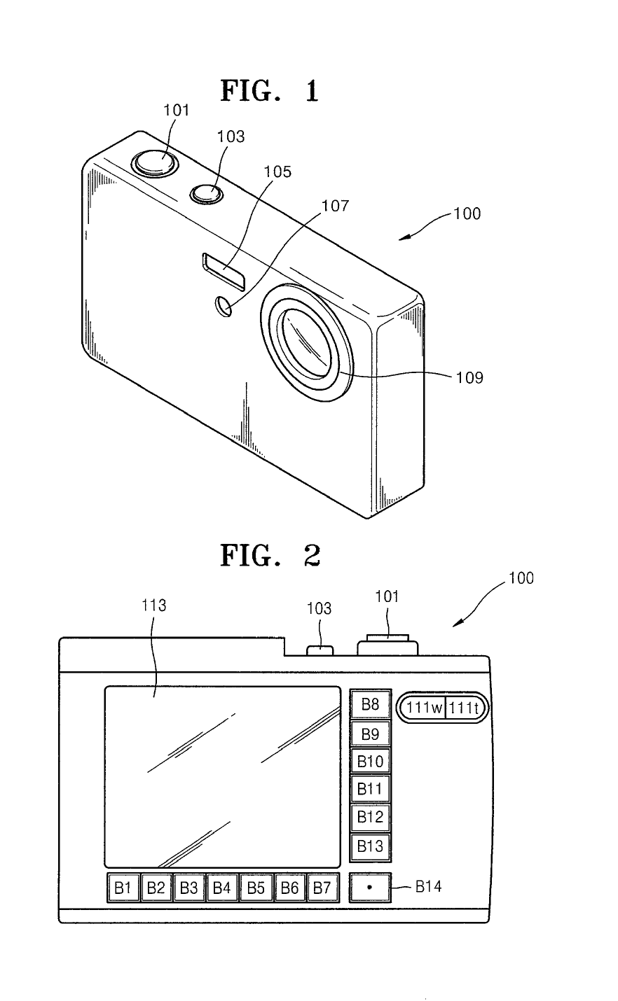

FIG. 1 is a perspective front view of an example of a digital image processing apparatus 100 according to an embodiment of the present invention.

Referring to FIG. 1, in an embodiment, the digital image processing apparatus 100 includes a shutter-release button 101 for exposing a charge-coupled device (CCD) or a film for a predetermined time to the incident light to record an image on the CCD.

In an embodiment, the shutter-release button 101 generates a first image photographing signal and a second image photographing signal according to a user input. When a first shutter-release signal, which is a half-shutter signal, is input, the digital image processing apparatus 100 adjusts a focus and light intensity. At this time, when an in-focus status is achieved, a green light is displayed on a display unit 113. When the image is focused and the light intensity is adjusted after the first shutter-release signal is input, a second shutter-release signal that is a full-shutter signal is input to take a photograph of the image.

A power button 103 supplies electric power to the digital image processing apparatus 100 to operate the digital image processing apparatus 100.

In an embodiment, a flash 105 instantly illuminates the subject when the photographing operation is performed in a dark place, and operates in such modes as an automatic flash mode, a forced flash mode, a flash off mode, a red-eye reduction mode, and a slow synchro mode.

In an embodiment, a sub-light 107 supplies light to the subject such that in the case of a lack of light or night photography, the digital image processing apparatus 100 can automatically adjusts the focus in a rapid and accurate way.

In an embodiment, light reflecting from the subject passes through a lens 109 for processes of an image of the subject by the digital image processing apparatus 100.

FIG. 2 is a rear view of the example of a digital image processing apparatus 100 illustrated in FIG. 1. Referring to FIG. 2, in an embodiment, the rear of the digital image processing apparatus 100 includes a wide-angle zoom button 111w, a telephoto zoom button 111t, the display unit 113, and input buttons B1 to B14 (hereinafter, referred to as ‘buttons B1 to B14’), wherein each button may include a touch sensor (not shown) or a contact switch (not shown).

In an embodiment, the wide-angle zoom button 111w or the telephoto zoom button 111t is pressed to respectively increase or decrease an angle of view, thereby changing the size of a selected exposure region to be photographed. When the wide-angle zoom button 111w is pressed, the size of the selected exposure region is reduced. When the telephoto zoom button 111t is pressed, the size of the selected exposure region is enlarged.

In an embodiment, the buttons B1 to B14 are arranged in a row and a column beside the display unit 113. As mentioned above, each of the buttons B1 to B14 arranged along the lateral and bottom sides of the display unit 113 includes a touch sensor (not shown) or a contact switch (not shown).

In an embodiment, if each of the buttons B1 to B14 includes a touch sensor, each of the buttons B1 to B7 arranged in a row or each of the buttons B8 to B14 arranged in a column is touched and moved upward, downward, to the left, or to the right, so that an arbitrary value (e.g., color or brightness) may be selected from a plurality of main menu icons or one of a plurality of sub-menu icons included in the main menu icons may be enabled.

In an embodiment, if each of the buttons B1 to B14 includes a contact switch, a main menu icon and a sub-menu icon can be directly selected to perform a desired function. When touch sensors are used, the operating force is smaller than the operating force for contact switches, and the contact switch needs to be touched more strongly than the touch sensor.

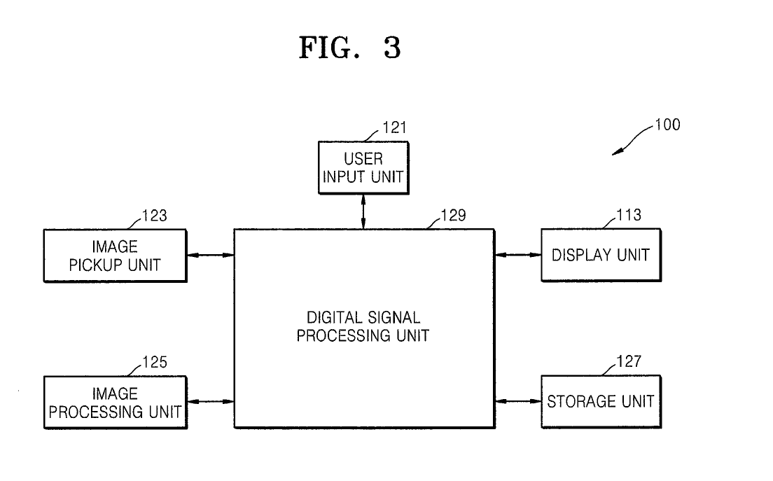

FIG. 3 is a block diagram illustrating an example of a structure of the digital image processing apparatus 100 illustrated in FIGS. 1 and 2. Referring to FIG. 3, in an embodiment, the digital image processing apparatus 100 according to the present embodiment includes the display unit 113, a user input unit 121, an image pickup unit 123, an image processing unit 125, a storage unit 127, and a digital signal processing unit 129.

In an embodiment, the user input unit 121 includes the shutter-release button 101, the power button 103, the wide-angle zoom button 111w and the telephoto zoom button 111t, and the buttons B1 to B14. The shutter-release button 101 is operated to expose a CCD to light for a predetermined time. The power button 103 is pressed to supply power to the digital image processing apparatus 100. The wide-angle zoom button 111w or the telephoto zoom button 111t is pressed to increase or decrease an angle of view. The buttons B1 to B14 are arranged in a row and a column beside the display unit 113. Each of the buttons B1 to B14 may include a touch sensor (not shown) or a contact switch (not shown).

In an embodiment, the image pickup unit 123 includes a shutter, a lens, a diaphragm, the CCD, and an analog-to-digital converter (ADC), although they are not shown. The shutter is a component that controls the amount of light entering the lens and the diaphragm. The lens receives light from an external light source. In an embodiment, the amount of light is controlled according to the extent by which the diaphragm is opened, which is regulated by the digital signal processing unit 129.

In an embodiment, the CCD accumulates light received via the lens and outputs an image picked up by the lens according to the amount of accumulated light in response to a vertical synchronizing signal. The CCD converts light reflected by a subject to be photographed into an electric signal. In order to obtain a full-color image using the CCD, a color filter is included in the digital image processing apparatus 100 of the present embodiment. The color filter may be a color filter array (CFA). The CFA includes regularly arranged pixels, each pixel allowing only single-color light to pass through, and may have various shapes according to the type of arrangement of pixels. The ADC converts an analog image signal output from the CCD into a digital signal.

In an embodiment, the image processing unit 125 processes raw digital data so as to display the data. The image processing unit 125 removes a black level caused by a dark current generated in the CCD and CFA, which are sensitive to temperature variations. The image processing unit 125 gamma encodes data in conformity with nonlinearity of a human's eyesight. The image processing unit 125 converts a Bayer pattern embodied by an RGRG line and a GBGB line of the gamma encoded data into an RGB line using CFA interpolation. The image processing unit 125 converts an interpolated RGB signal into a YUV signal, performs an edge compensation process of filtering a Y signal using a high pass filter (HPF) to process an image clearly, performs a color correction process of correcting color values of U and V signals using a normal color coordinate system, and eliminates noise from Y, U, and V signals. The image processing unit 125 compresses and processes the Y, U, and V signals, from which noise is eliminated, to generate a joint photographic coding experts group (JPEG) file, and the generated JPEG file is displayed on the display unit 113 and stored in the storage unit 127. The above-described operations of the image processing unit 125 are controlled by the digital signal processing unit 129.

In an embodiment, when an image is photographed, the digital signal processing unit 129 displays the image of the subject incident, a preview image, on the display unit 113, and at the same time, displays the photographed image, that is, a quick view image, on the display unit 113 for a predetermined time. Embodiments of the present invention have the advantage that when a user activates the quick view function, a photographing operation can be performed and a preview image viewed while viewing the quick view image.

In an embodiment, the digital image processing apparatus 100 according to the current embodiment of the present invention displays a quick view image on a part of a preview image as a pop-up window. In an embodiment, the preview image is displayed on the display unit 113, simultaneously with the quick view image, which may be displayed on a part of the display unit 113 as a picture-in-picture (PIP) type.

In an embodiment, the user may set a quick view/preview support mode. The user may set the display unit 113 to display the quick view image on a part of the preview image as a pop-up or a PIP. In an embodiment, the user can set a location of the pop-up window of the quick view image, a size of the pop-up window of the quick view image, and a time of displaying the quick view image (for example, sec., 0.5 sec., 1 sec., or 3 sec.) in the display unit 113 using the buttons (B1 to B14 in FIG. 2).

In an embodiment, when the user inputs the second shutter-release signal when the quick view/preview support mode is set, an image file is generated and stored. In an embodiment, a thumbnail image for the quick view is generated and stored.

In an embodiment, the digital signal processing unit 129 displays the image of the subject incident through the image pickup device, that is, the preview image, on the display unit 113, and at the same time, displays the photographed image, that is, the quick view image, on the display unit 113 for a predetermined time.

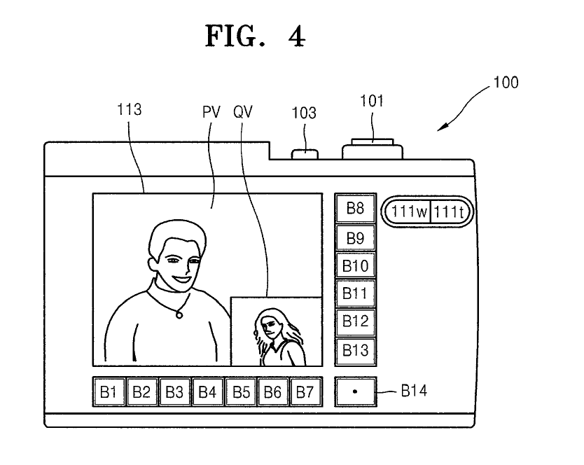

Referring to FIG. 4, in an embodiment, the quick view image and the preview image are displayed simultaneously on the display unit 113. After performing the photographing operation once, the preview image PV for the next photographing operation is displayed on the display unit 113. At the same time, the quick view image QV of the previous photographed image is displayed on a part of the display unit 113.

In an embodiment, when the user inputs the second shutter-release signal, the next photographing operation can be performed while the quick view image QV is displayed on the display unit 113. Embodiments have the advantage that a photographing operation can be performed while displaying the quick view image, and thus, a time interval between photographing operations may be reduced. Embodiments have the further advantage that when other signals, for example, signals for setting modes or changing modes, are input, the operations corresponding to the signals can be performed immediately while displaying the quick view image.

In an embodiment, when a predetermined time for displaying the quick view image pop-up window elapses the digital image processing unit 129 stops displaying the quick view image QV.

In an embodiment, the quick view image and the preview image may be displayed at the same time, and thus, time intervals between photographing operations can be reduced. In an embodiment, the user may use the photographing function or other functions of the digital image processing apparatus 100 even when the quick view image is displayed on the display unit 113.

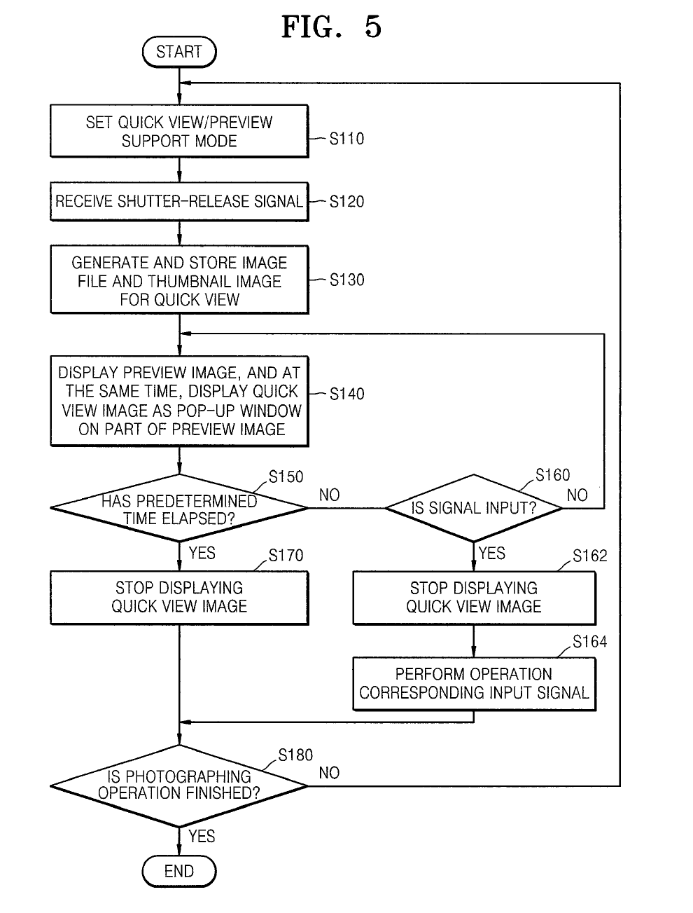

In addition, a method of controlling the digital image processing apparatus 100 will be described in detail with reference to FIG. 5. FIG. 5 is a flowchart illustrating an example of a method of controlling the digital image processing apparatus 100, according to an embodiment of the present invention. In an embodiment, the method of controlling the digital image processing apparatus of the present invention can be performed in the digital image processing apparatus 100 illustrated in FIG. 3, and the functionality of the controlling method may be performed in the digital signal processing unit 129 with peripheral components.

Referring to FIG. 5, in an embodiment, the method of controlling the digital image processing apparatus 100 includes a step of setting a quick view/preview support mode (S110), a step of inputting the shutter-release signal (S120), a step of generating and storing the image file and the thumbnail image for the quick view (S130), a step of displaying the preview image and displaying the quick view image on a part of the preview image as a pop-up (S140), a step of determining whether a predetermined time has elapsed (S150), if the predetermined time does not elapse, a step of determining whether a predetermined signal is input by the user (S160), a step of suspending the display of the quick view image when the user inputs the predetermined signal (S162), a step of performing an operation corresponding to the predetermined signal (S164), and a step of suspending the display of quick view image if the predetermined time has elapsed (S170).

In S110, the user sets the quick view/preview support mode. That is, the user sets the quick view image to be displayed with the preview image on a part of the preview image as a pop-up type. In an embodiment, the user may adjust the location of the quick view pop-up window, the size of the pop-up window, and the time of displaying the pop-up window (for example, 0 sec., 0.5 sec., 1 sec., or 3 sec.) using the buttons (B1 to B14 of FIG. 2).

Next, the shutter-release signal is input in S120, and the image file and the thumbnail image for the quick view are generated and stored in S130. In an embodiment, the digital signal processing unit 129 (refer to FIG. 3) receives the shutter-release signal, and controls the image processing unit 125 (refer to FIG. 3) to generate a JPEG image file of the photographed image and store the JPEG image file in the storage unit 127 (refer to FIG. 3). In an embodiment, at the same time, the digital signal processing unit 129 generates the thumbnail image for the quick view image and stores the generated thumbnail image.

Then the preview image is displayed on the display unit 113, and at the same time, the photographed image, that is, the quick view image, is displayed on the display unit 113 for a predetermined time in S140. In an embodiment, after the subject is photographed once, the display unit 113 displays the preview image for the next photographing operation. In an embodiment, at the same time, the quick view image of the previous photographed image is displayed on a part of the display unit 113.

In an embodiment, the digital signal processing unit 129 determines whether the predetermined time of displaying the pop-up window of the quick view image has elapsed in S150.

When the predetermined time has not elapsed as a result of the determination in S150, it is determined whether the user inputs a predetermined signal in S160. In an embodiment, when the user does not input the predetermined signal, the preview image and the quick view image are continuously displayed on the display unit 113.

In an embodiment, when the user inputs the predetermined signal, the display of the quick view image is stopped in S162, and the operation corresponding to the input signal is performed in S164. For example, when the user inputs the shutter-release signal, the next photographing operation can be performed even when the quick view image is displayed on the display unit. In addition, when other signals, for example, signals for setting a mode or changing a mode, are input, the operations corresponding to the input signals can be performed immediately.

When the predetermined time has elapsed as a result of the determination in S150, the display of the quick view image is stopped in S170. In an embodiment, when the predetermined time of displaying the pop-up window of the quick view image has elapsed, the display of the quick view image is stopped, and the image of the subject incident into the image pickup device, that is, the preview image, is only displayed on the display unit 113.

Then, in an embodiment, it is determined whether the photographing operation is finished in S180, and when the photographing operation is not finished, the above processes are repeatedly performed.

According to the present invention, since a quick view image and a preview image are displayed at the same time, time intervals between photographing operations can be reduced. In addition, even when a quick view image is displayed, the user may use other functions, for example, the next photographing operation.

Embodiments comprise a computer readable medium encoded with computer-executable instructions to perform a method. The computer readable medium includes RAM memory, flash memory, ROM memory, EPROM memory, EEPROM memory, registers, a hard disk, a removable disk, a CD-ROM, or other forms of computer readable media known in the art.

For convenience, in the description above, the functionality described has been divided into a number of units; however, the number of units may vary and the functionality described above may be differently divided among the units, or the functionality described above may be implemented without units.

The various illustrative units described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital image processing apparatus configured to simultaneously display a quick view image and a preview image.

2. The digital image processing apparatus of claim 1, further configured to display the quick view image on the preview image in a form of a picture-in-picture (PIP).

3. The digital image processing apparatus of claim 1, further configured to display the quick view image on the preview image for a predetermined time after a first photographing operation is finished.

4. The digital image processing apparatus of claim 1, further configured to perform a second photographing operation while the quick view image is being displayed on the preview image.

5. The digital image processing apparatus of claim 1, further configured to adjust at least one of a location of the quick view image in the preview image, a size of the quick view image, and a time of displaying the quick view image according to a user input.

6. A digital image processing apparatus comprising:
a display unit; and
a digital signal processing unit, after photographing an image, displaying an image of a subject incident into an image pickup device on the display unit, and displaying a photographed image on the display unit at the same time.

7. The digital image processing apparatus of claim 6, wherein the digital signal processing unit controls the display unit to display the photographed image on the image of the subject that is incident into the image pickup device as a pop-up window for a predetermined time.

8. The digital image processing apparatus of claim 6, wherein the digital image processing apparatus is configured to perform a next photographing operation while the photographed image is being displayed on the display unit.

9. The digital image processing apparatus of claim 6, wherein the digital image processing apparatus is configured to respond to user input by at least one of adjusting a location of displaying the photographed image in the display unit, adjusting a size of the photographed image, and setting a time of displaying the photographed image.

10. The digital image processing apparatus of claim 6, wherein the digital signal processing unit is configured to control the display unit to stop displaying the photographed image when a predetermined time elapses.

11. A method of controlling a digital image processing apparatus comprising a display unit, the method comprising:
responsive to receiving a shutter-release signal, generating and storing an image file of a photograph;
simultaneously displaying a preview image and the image file on the display unit; and
stopping the displaying of the image file after a predetermined time elapses.

12. The method of claim 11, wherein responsive to receiving further comprises:
generating and storing a thumbnail image of the image file for displaying.

13. The method of claim 11, wherein, the simultaneously displaying further comprises simultaneously displaying the image file on the display unit as a pop-up window for the predetermined time.

14. The method of claim 11, further comprising responsive to a predetermined signal input by a user during simultaneously displaying, performing an operation corresponding to the predetermined signal.

15. The method of claim 11, further comprising responsive to a shutter-release signal input by a user while simultaneously displaying, performing a next photographing operation.

16. A computer readable medium encoded with computer-executable instructions to perform a method comprising:
responsive to receiving a shutter-release signal, generating and storing an image file of a photograph;
simultaneously displaying a preview image and the image file on the display unit; and
stopping the displaying of the image file after a predetermined time elapses.
